(19) United States
(12) Patent Application Publication
(10) Pub. No.: US 2026/0023267 A1
(43) Pub. Date: Jan. 22, 2026

(54) FORT'S MEDI -VIEW MAGNIFY LENS AND CASE

(71) Applicant: Paulette Nicole Briggs, Indpls, IN (US)

(72) Inventor: Paulette Nicole Briggs, Indpls, IN (US)

(21) Appl. No.: 18/779,991

(22) Filed: Jul. 22, 2024

(51) Int. Cl. G02B 27/02; G02B 25/00

(52) U.S. Cl. CPC G02B 27/021; G02B 25/008; G02B 27/028

(57) ABSTRACT

The only unique appearance is the authentic manuscripts and art on the drawings on the magnify lens and case. The difference from average cases is this case is created for the purpose of relieving stress with arts for critical care patients for example, cardiology patients. It could be utilized while screening the stressed patients and preventing inaccurate results from micro-small text that is the cause of statistical deaths caused by misread medical instructions.

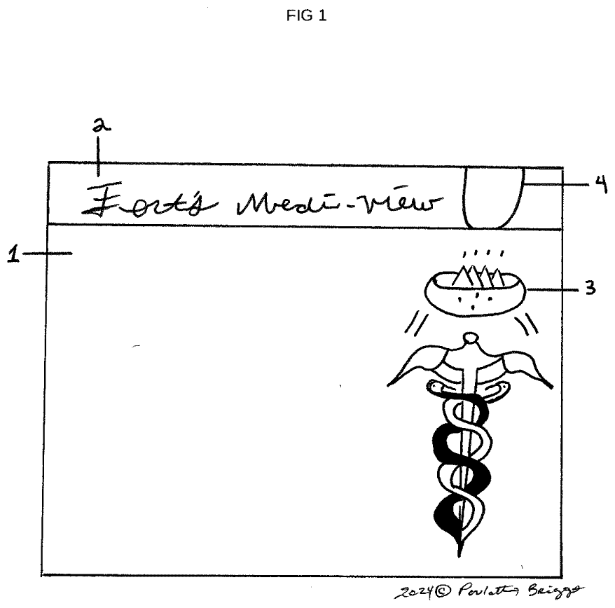

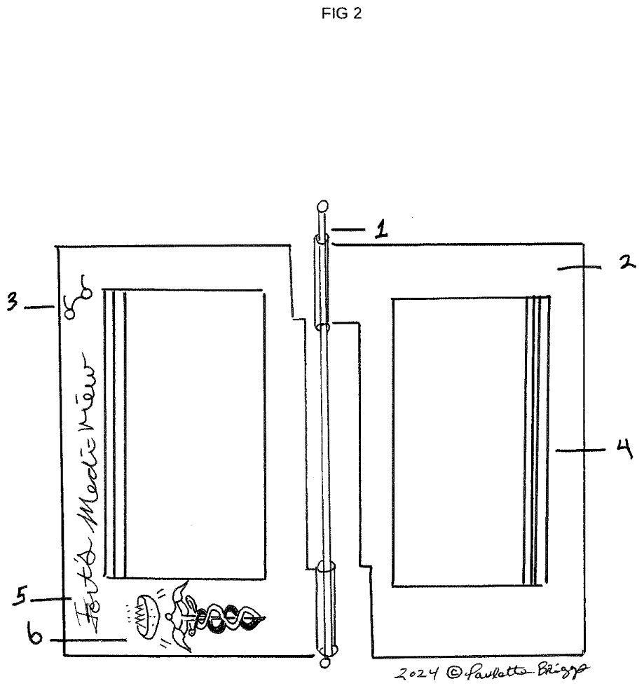

The arts separate from this application are created to insert in the case for the purpose of art therapy that caters to the patient to lower stress for all as in their home environment.

### BACKGROUND

The endeavor entirely is the prevention of Disease with the use of Arts to progress a socially and physically healthy environment. The initial goal and attempt after mistrial and error for the prior application was to use the same business domain to advertise therapeutic and healthy products and to secure a profitable prototype that promotes a healthy living and pollution free environment. The first attempt and relation was the attempt for USPTO patent application Ser. No. 16/731,723 for an optical device GOD OID that was only art and a magnifying lens that was for the purpose of creating a healthy medical environment and safe practices due to encountering micro text medical/prescription instructions.

The interest for art and healthy environment flourished to ideas to create products that influence the prevention of property hazards that improve the welfare of all, overall. This second attempt for the patent application is a similar concept as the first except a different product. It was created for critical cardiology patients as all patients in a stressful environment to lower elevated blood pressure with the use of arts and a magnifying lens. The first attempt for the GOD OID as the Forts Groups Medi View is for safety precautions in a medical setting and to secure a profitable prototype. The goal is to offer an approved series of shapes and display of various new accessory arts, and designs for magnifying lenses as other therapeutic products under the same Trademarks for adults and children to use for therapy to progress a lower stress environment.

The Medi View is an assurance for professionals to view micro to small text on medical instructions, medications, as patients in their home environment. The background is a plan to stay the standards of laws required to secure a safe environment. The Medi View is an asset that ensures more precise results and grants a lower percentage for misdiagnosis, accidental deaths due to misread medical instructions and errors. The Medi View is a reassurance for professionals as well that the most accurate diagnosis is a guarantee of a professional's liability for prescribing critical medications. The simple art and lens is a remedy for patients with borderline elevated blood pressures by being a display of an Anti-Stress art therapy product. In closing the Medi View is meeting safety regulations while being a desirable art display.

### Evidence of Related Websites Links 1-16 as Follows 1 thru 6,

1. https://www.ncbi.nlm.nih.gov/books/NBK269495
2. https://www.psychologytoday.com/us/blog/arts-and-health/201805/art-therapy-the-role-th e-relationship
3. https://www.ncbi.nlm.nih.gov/pmc/articles/PMC3035877/
4. https://www.fda.gov/about-fda/center-drug-evaluation-and-research-cder/otc-labeling-que stions-and-answers
5. https://www.cdc.gov/chronicdisease/resources/publications/aag/heart-disease-stroke.htm
6. https://www.pharmaceutical-journal.com/news-and-analysis/mhra-seeks-views-on-remov in-small-print-from-medicines-advertisements/11135462.article

1. The emergent need for the Forts Medi View lens is intended to enlarge micro-small text of difficult to view medical instructions to prevent errors.

2. The art inserts are intended to be used for art therapy to relieve stress, psychological disorders when critical care is an issue.

3. The convenience of the folding art case with drawers for magnifying lenses, may also be utilized by patients that are visually disadvantaged.

5. The Medi View is created to prevent hindrance by being readily accessible due to convenient size when work flow is heavy

6. The Medi View magnify lens is necessary to prevent eye diseases such as cataract by alleviating straining of the eyes.
